(19) United States
(12) Patent Application Publication
(10) Pub. No.: US 2011/0181722 A1
(43) Pub. Date: Jul. 28, 2011

(54) TARGET IDENTIFICATION METHOD FOR A WEAPON SYSTEM

(76) Inventors: William G. Gnesda, Imperial Beach, CA (US); James J. Farquhar, Coronado, CA (US)

(21) Appl. No.: 12/693,946

(22) Filed: Jan. 26, 2010

(51) Int. Cl. H04N 7/18

(52) U.S. Cl. 348/148; 348/E07.085

(57) ABSTRACT

A target identification method for a remote weapon system may be installed on a land or sea-based vehicle. The remote weapon system may include a camera array with at least one exterior camera, which may be an infrared camera. The camera array may be used in conjunction with pattern recognition software that improves the ability of the system to identify objects in the scanning area around the vehicle. The pattern recognition software may be used to identify light sources during nighttime operations.

### BACKGROUND OF THE INVENTION

1. Field of the Invention

The present invention generally relates to weapon systems. The present invention more specifically relates to a weapon system that incorporates a target identification method to eliminate light sources for nighttime operations.

2. Background Art

In some instances military operations, are best accomplished under cover of darkness; especially those carried out by Special Forces and covert operations units. Such operations are scheduled to take place during the night. Any source of light can be a disadvantage in such scheduled operations.

One of the tools used in many military operations is a remote weapon system. A remote weapon system is designated as such because it may be fired by a gunner who is not in physical contact with the weapon. The remote weapon system typically utilizes a light or medium caliber gun mounted on a vehicle. Display systems provide target information to gunners who can view and evaluate the information. Servo systems for the weapon allow the gunner to manipulate and lock on a target and then fire the weapon from the relative safety of the interior of the vehicle.

A shortcoming of current art weapon systems is that they do not provide an effective means of locating and displaying targets while eliminating light sources for operations that are intended to be carried out in darkness.

### SUMMARY OF THE CLAIMED INVENTION

An exemplary embodiment of the technology described herein is an improved target identification method for a remote weapon system. The system may be installed on a land or sea-based vehicle. The gun utilized in the system will typically be a light or medium caliber automatic weapon.

The remote weapon system may include a camera array with at least one exterior camera to provide a visual image of the area surrounding the vehicle. The feed from multiple cameras may be combined and displayed on a screen to provide a gunner with a 360 degree scan view around the vehicle. A separate image may be provided to show the target area toward which the gun is directed at any given time.

The camera array may include infrared cameras, radar, and laser-based detection units. The infrared cameras utilized may typically be forward looking infrared (FLIR) cameras. A transform map may be provided with the FLIR sensor arrays to modify a measured input signal to an appropriate level for the output signal. A linear transform map may be applied to the sensor array output to provide a standardized output signal that compensates for variations in the sensitivities of the arrays from pixel to pixel.

The camera array may further include a digital image processing subsystem to digitally enhance the image produced by the camera array. Digital processing may be used to improve the quality of the output image.

The remote weapon system may include a joystick that allows the gunner to control the motion of the gun via a servo mechanism. The servo mechanism of the gun may include a gyroscope-based leveling mechanism to allow the servo mechanism to compensate for motion of the vehicle relative to the target. The servo mechanism may be controlled by automatic target acquisition software to aim the weapon at a selected target.

The target acquisition software may also include pattern recognition software. The pattern recognition software improves the ability of the weapon system to identify various objects in the scanning area around the vehicle. The pattern recognition software may be used to identify light sources during nighttime operations. The software looks for regular geometric patterns in an effort to identify manmade light sources. Removal of these light sources is beneficial to nighttime operations during which complete darkness is optimal.

### BRIEF DESCRIPTION OF THE DRAWINGS

FIG. 1 illustrates a system utilizing the target identification method mounted on a land based vehicle.

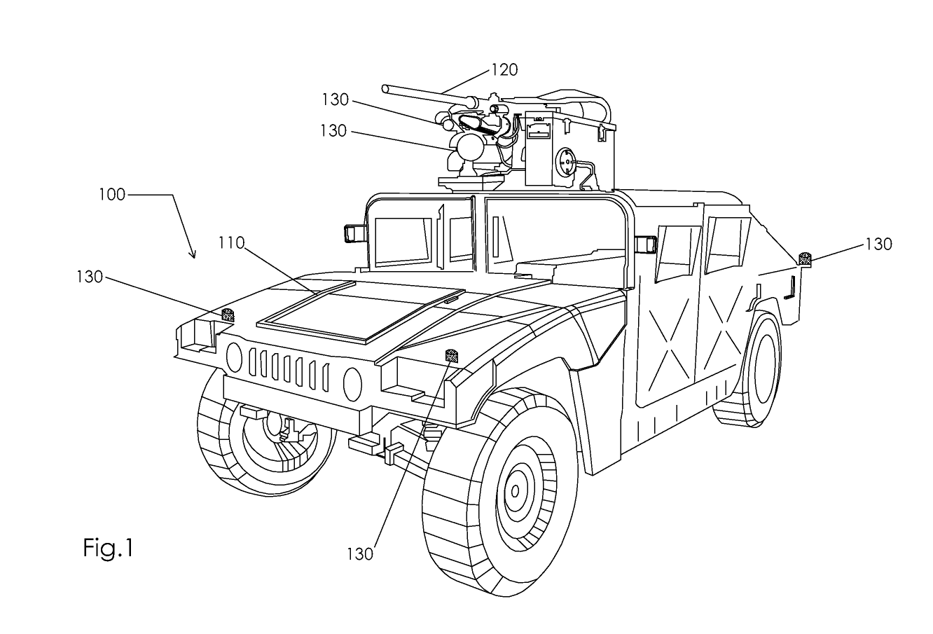

FIG. 2 depicts an exemplary control center for the system.

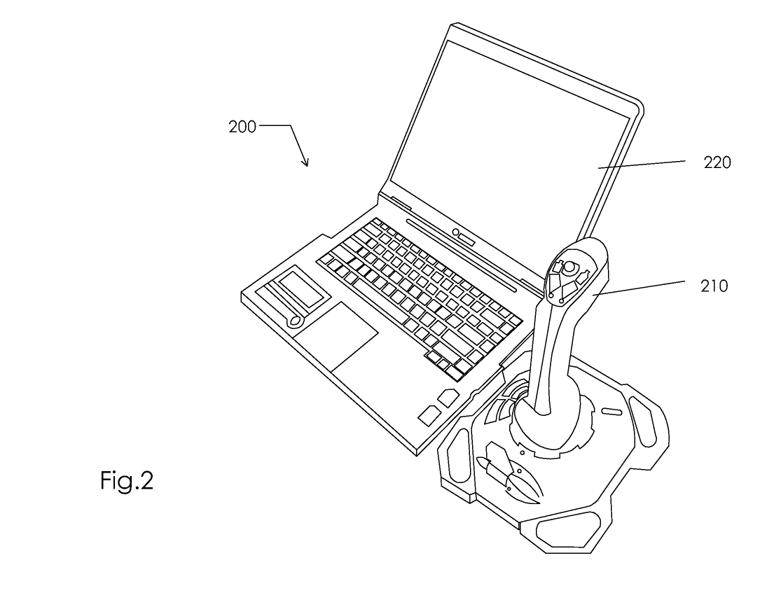

FIG. 3 is a flowchart of a target identification method.

FIG. 4 is a schematic diagram of a computer system supporting the target identification method.

### DETAILED DESCRIPTION

Described herein is a method of target identification for a remote weapon system 100. A remote weapon system is a system that allows the weapon to be fired by a gunner who is not in physical contact with the weapon. The remote weapon system 100 may be installed on a land or sea-based vehicle 110 as a part of a mobile weapon platform. At least one weapon utilized in the remote weapon system 100 will typically be a light or medium caliber automatic weapon. Other types of weaponry may be utilized in the context of the mobile weapon platform, including projective weapons, laser-based weapons, as well as heat and audio based weaponry. The remote weapon system described herein provides a high level of mobility to the weapon system, while also providing protection to a gunner by allowing the gunner to fire the weapon from the interior of the vehicle.

A gun 120 used in the remote weapon system 100 may be controlled by a computer operated servo mechanism. The servo mechanism is communicatively coupled to a control center 200 which may be located in an interior of the vehicle 110. The control center 200 includes a joystick 210 or other apparatus accessible from the interior of the vehicle 110, thereby allowing the operator to control the movement of the gun 120 while remaining safely in the interior of the vehicle 110.

The gun servo mechanism may include a gyroscope-based stabilizing mechanism. The stabilizing mechanism operates to counterbalance movement of the vehicle detected by the stabilizing system. The stabilizing mechanism allows a gunner to keep the gun trained on a target even if the vehicle is moving at a high rate of speed over rough terrain or water.

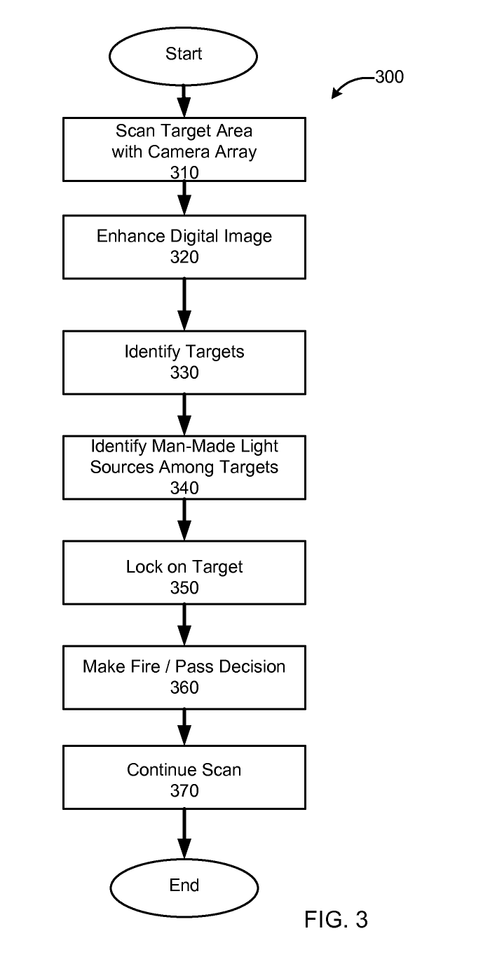

FIG. 3 is a flowchart of a target identification method 300. In step 310 a scan of a target area is provided by a camera array 130 installed on a mobile weapon platform. The camera array 130 includes at least one exterior camera that records moving images in a digital format. In one example, four to eight cameras are provided in the camera array 130.

The camera array 130 may generate a 360-degree horizontal scan of the target area, which allows a gunner to have a visual image of the area surrounding the vehicle 110 or other environment in which the weapon system is installed. The 360 degree image is provided to the gunner or other observer in the control center 200. The digital visual image feed from multiple cameras may be combined and displayed on a single display screen 220. Simultaneously displaying the feeds from multiple cameras is one method of providing the gunner with 360 degree visibility of the area surrounding the vehicle.

Another method of providing 360 degree visibility is to utilize the servo mechanism of the gun 120. A camera may be installed so that it rotates with the gun 120. The camera thus installed will provide a 360 degree visual scan in the time required for a 360 degree rotation of the gun 120. The full rotation time may be less than one second.

The camera array 130 may also include infrared sensors, radar, and laser-based detection devices. When infrared sensors are utilized, the camera array 130 may include forward looking infrared (FLIR) cameras. FLIR cameras are used to detect heat emission patterns from objects in the scanned area. The FLIR cameras may use the detected heat emission patterns to create an image that is displayed to the operator. Through this process, FLIR cameras may provide a real-time infrared image of the area surrounding the camera array and corresponding mobile weapons platform. Other infrared systems use successive readings of images of an object over time, but may not provide a real-time infrared view.

Due to the fact that sensitivity of infrared sensors may vary significantly from pixel-to-pixel, a transform map may be utilized in conjunction with a sensor array. The transform, which is typically a linear transform, performs a normalization function to ensure that the pixel outputs throughout the sensor array are uniform with respect to a standard input. The linear transform may be included with a software package that is executable by a processor or processors that control the sensor array. The software package may be included when the sensor array is conveyed to an end user.

An image separate from the 360-degree scan may be displayed to show the gunner the target area toward which the gun is directed at any given point in time. The target display may include crosshairs to show the gunner where the gun is aimed. Once the gun or weapon is directed at a target or other area of interest at which the gunner chooses to fire, the gunner actuates a trigger on the joystick to fire the weapon.

The method 300 may further include a subsystem that allows for an optional step 320 of detected digital image enhancement to take place. Digital enhancement techniques that may be included in executable software and as a part of method 300 may include image correction and edge enhancement.

Pattern recognition software may also be included in image processing software executed as a part of method 300. In a target identification step 330, targets may be identified by heat generation, by visual image, and/or by use of the pattern recognition software to identify geometric shapes.

In step 340 identification of a particular geometric pattern such as a regular geometric pattern may allow for faster identification and isolation of manmade objects, such as light sources. The pattern recognition software identifies the manmade objects by focusing on objects with regular geometric patterns such as straight lines and regular curvatures.

When an object has been identified as a potential target, a lock on target in step 350 may cause the target acquisition software to automatically aim the weapon toward the identified target. The target acquisition software may include software that controls a mechanical servo system of the weapon. The target acquisition software may record the position of the identified target, and may then manipulate the servo mechanism to aim the weapon at the target. In one embodiment, the servo mechanism may include a gyroscope-based leveling mechanism to allow the servo mechanism to compensate for motion of the vehicle relative to the target.

Nighttime operations are often insertion/extraction operations in which the absence of light is an advantage. In such operations, the target identification method may be used in a light elimination mode to allow the gunner to identify and eliminate light sources. In the light elimination mode, potential targets may be reduced only to manmade light sources. As the vehicle approaches a target area, such as an insertion/extraction point, the camera array may perform a 360 degree scan of the area, and the pattern recognition software may process the images collected by the camera array. If a light source is displayed by the camera array and confirmed by the pattern recognition software as a manmade light source, the target acquisition software may use the lock on step 350 to isolate an image of the light source and direct the servo mechanism to aim the weapon toward the light source.

Once a potential target has been displayed to the gunner, the gunner may be offered a decision as to whether to fire or pass on firing upon the target in step 360. In the fire/pass step 360, if the gunner confirms from the information provided by the target acquisition system in conjunction with the pattern recognition software that the target should be eliminated and that the crosshairs are locked on the target, the gunner fires the gun to eliminate the light source, which may be representative of a threat to the vehicle employing the mobile weapon platform. The gunner may also pass on the target, and allow the method 300 to continue the scan to a succeeding target in step 370.

The target acquisition system and the pattern recognition software may have the capacity to make further delineations of a light and/or heat source identified by the camera array. The method 300 may be able to distinguish between heat generated by a human body and that generated by an animal by considering the amount of heat generated and the pattern in which the heat is radiated. The method 300 may also allow the camera array to identify various weapons, vehicles, and aircraft, by comparing isolated images against stored images of known weapons, vehicles, and aircraft. Finally, the system may identify various uniforms, and concurrently label them as worn by friend or foe, by comparing scanned images against stored images of known uniforms.

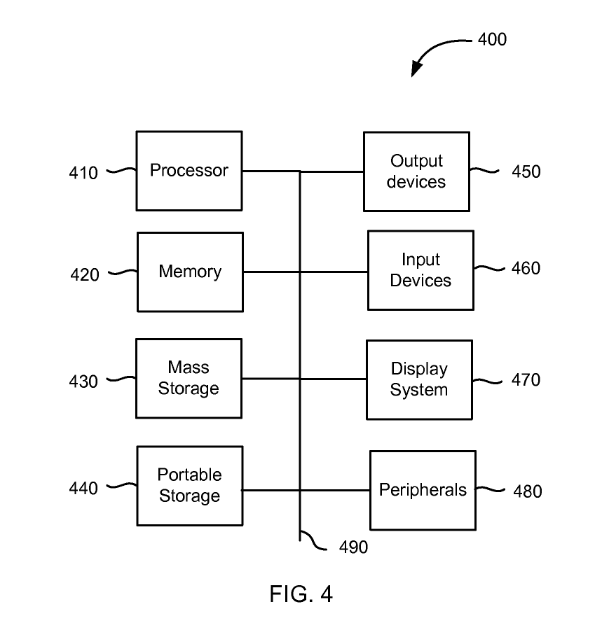

FIG. 4 illustrates an exemplary computing system 400 that may be used to implement an embodiment of the present technology. The computing system 400 includes one or more processors 410 and main memory 420. Main memory 420 stores, in part, instructions and data for execution by processor 410. Main memory 420 can store the executable code when in operation. The computing system 400 may further include a mass storage device 430, portable storage medium drive(s) 440, output devices 450, user input devices 460, a graphics display 470, and peripheral device(s) 480.

The components shown in FIG. 4 are depicted as being connected via a single bus 490. The components may be connected through one or more data transport means. The processor 410 and the main memory 420 may be connected via a local microprocessor bus, and the mass storage device 430, the peripheral devices 480, the portable storage medium drive(s) 440, and display system 470 may be connected via one or more input/output (I/O) buses.

The mass storage device 430, which may be implemented with a magnetic disk drive or an optical disk drive, is a non-volatile storage device for storing data and instructions for use by the processor 410. The mass storage device 430 can store the system software for implementing embodiments of the present invention for purposes of loading that software into the main memory 420.

The portable storage device 440 operates in conjunction with a portable non-volatile storage medium, such as a floppy disk, compact disk, digital video disc, or USB storage device, to input and output data and code to and from the computer system 400 of FIG. 4. The system software for implementing embodiments of the present invention may be stored on such a portable medium and input to the computer system 400 via the portable storage device 440.

The input devices 460 provide a portion of a user interface. The input devices 460 may include an alpha-numeric keypad, such as a keyboard, for inputting alpha-numeric and other information, or a pointing device, such as a mouse, a trackball, stylus, or cursor direction keys. Additionally, the computing system 400 as shown in FIG. 4 includes the output devices 450. Suitable output devices include speakers, printers, network interfaces, and monitors.

The display system 470 may include a liquid crystal display (LCD) or other suitable display device. The display system 470 processes any information it receives for output to the display device.

The peripheral device(s) 480 may include any type of computer support device to add additional functionality to the computer system. The peripheral device(s) 480 may include a modem or a router.

The components contained in the computer system 400 of FIG. 4 are those typically found in computer systems that may be suitable for use with embodiments of the present invention and are intended to represent a broad category of such computer components that are well known in the art. Thus, the computer system 400 of FIG. 4 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, webOS, Android, iPhone OS and other suitable operating systems.

It should be noted that some of the above-described functions performed in the method 300 may be defined by instructions that are stored on storage media (e.g., computer-readable media). The instructions may be retrieved and executed by the processor of the computer on which the system is resident. Some examples of storage media are memory devices, tapes, disks, integrated circuits, and servers. The instructions are operational when executed by the processor to direct the processor to operate in accord with the invention. Those skilled in the art are familiar with instructions, processor(s), and storage media.

It should also be noted that any hardware platform suitable for performing the processing described herein is suitable for use with the invention. The terms “computer-readable media” and “storage media” as used herein refer to any medium or media that can be used to provide instructions to a CPU for execution.

Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise an embodiment of a bus. Transmission media can also take the form of acoustic or light waves, such as those generated during radio frequency (RF) and infrared (IR) data communications.

Common forms of computer-readable media include, for example, a floppy disk, a flexible disk, a hard disk, magnetic tape, any other magnetic medium, a CD-ROM disk, digital video disk (DVD), any other optical medium, a physical medium with patterns of marks or holes, a RAM, a PROM, an EPROM, an EEPROM, a FLASHEPROM, any other memory chip or cartridge, a carrier wave, or any other medium from which a computer can read.

The embodiments described herein are illustrative of the present invention. As these embodiments of the present invention are described with reference to illustrations, various modifications or adaptations of the methods and or specific structures described may become apparent to those skilled in the art in light of the descriptions and illustrations herein. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method of identifying a target image, the method comprising:
scanning a target area with a camera array installed on a mobile weapon platform;
displaying an image of at least a portion of the target area on a display device coupled to the camera array;
executing software stored in memory to identify objects within the displayed image as potential targets;
allowing a gunner to choose to fire a weapon at an identified potential target or to pass the identified potential target; and
displaying a succeeding potential target.

2. The method of claim 1, wherein scanning a target area includes using at least one infrared sensor.

3. The method of claim 1, wherein scanning a target area includes using at least one forward looking infrared camera.

4. The method of claim 1, wherein scanning a target area provides a 360 degree view of an area around the mobile weapon platform.

5. The method of claim 4, wherein displaying an image of the target area includes displaying a 360 degree view of an area around the mobile weapon platform while simultaneously displaying a separate view of an identified object.

6. The method of claim 1, wherein identifying objects includes identifying potential targets and subsequently aiming a weapon of the mobile weapon platform toward at least one object.

7. The method of claim 1, wherein identifying objects includes executing pattern recognition software to isolate any objects with regular shapes, and subsequently aiming a weapon of the weapon platform toward at least one object.

8. The method of claim 1, wherein identifying objects includes executing pattern recognition software to isolate manmade light sources, and subsequently aiming a weapon of the weapon platform toward at least one light source.

9. The method of claim 1, wherein identifying objects includes distinguishing between animal and human heat sources.

10. The method of claim 1, wherein identifying objects includes executing pattern recognition software to isolate manmade light sources.

11. The method of claim 1, wherein identifying objects includes comparing scanned images against stored images of weapons, vehicles, and aircraft.

12. The method of claim 1, wherein identifying objects includes comparing scanned images against stored images of uniforms.

13. A weapon system, the system comprising:
a weapon mounted on a mobile platform;
a camera array installed on the mobile platform;
a display capable of depicting a simultaneous display of a 360 degree scanned area and an object identified as a potential target within the 360 degree scanned area; and
target acquisition software stored in memory and executable to control a servo system to aim the weapon at the potential target.

14. The system of claim 13, wherein the camera array includes at least one infrared sensor to detect heat sources.

15. The system of claim 13, wherein the camera array includes at least one forward looking infrared camera to detect generated heat and to form an image of the object generating the heat.

16. The system of claim 13, wherein the camera array identifies potential targets, and the target acquisition software is executable to subsequently aim the weapon toward at least one potential target.

17. The system of claim 13, wherein the identification process includes executing pattern recognition software to isolate any objects with regular shapes, the pattern recognition software subsequently cooperating with target acquisition software to aim the weapon toward an isolated object.

18. The system of claim 13, wherein the camera array includes pattern recognition software to isolate any manmade light source, the pattern recognition software cooperating with target acquisition software to aim the weapon toward an identified light source object.

19. The system of claim 13, wherein the identification software distinguishes between animal and human heat sources.

20. The system of claim 13, wherein the identification software identifies specific weapons, vehicles, and aircraft.
